(19) United States
(12) Patent Application Publication
(10) Pub. No.: US 2012/0007979 A1
(43) Pub. Date: Jan. 12, 2012

(54) MULTISPECTRAL ENHANCED VISION SYSTEM AND METHOD FOR AIRCRAFT LANDING IN INCLEMENT WEATHER CONDITIONS

(75) Inventors: Ron Schneider, Haifa (IL); Ofer David, Haifa (IL); Dror Yahav, Haifa (IL)

(73) Assignee: Elbit Systems Ltd. Advanced Technology Center, Haifa (IL)

(21) Appl. No.: 12/988,284

(22) PCT Filed: Apr. 7, 2009
(86) PCT No.: PCT/IL2009/000390

§ 371 Date: Mar. 14, 2011

Related U.S. Application Data
(60) Provisional application No. 61/045,460, filed on Apr. 16, 2008.

(51) Int. Cl. H04N 7/18

(52) U.S. Cl. 348/116; 348/E07.085

(57) ABSTRACT

Apparatus for detecting airfield light emitters, the apparatus including a plurality of light detection cameras, each detecting at least one respective waveband of electromagnetic radiation within the electromagnetic spectrum, each of the light detection cameras producing a plurality of respective spectral images, and a processor coupled with the light detection cameras, thereby generating a multispectral image of the airfield light emitters from the spectral images, the multispectral image including a multi-dimensional set of spectral values, wherein the processor further determines which combination the multi-dimensional set of spectral values corresponds with a plurality of distinct light emission characteristics of the airfield light emitters by identifying a particular spectral signature corresponding to the multi-dimensional set of spectral values, wherein the processor produces an enhanced image from those spectral values of the multi-dimensional set of spectral values which correspond to the determined combination.

### FIELD OF THE DISCLOSED TECHNIQUE

The disclosed technique relates to enhanced vision systems, in general, and to a multispectral enhanced vision system and method for assisting a pilot of an aircraft during inclement weather conditions, in particular.

### BACKGROUND OF THE DISCLOSED TECHNIQUE

Enhanced vision systems (EVS) operational on aircraft are used to enhance the ability of the pilot of the aircraft to decent toward landing, decrease landing minima, and as well as to improve the flight safety, especially during adverse weather conditions, by enhancing the situational awareness of the pilot. Such systems typically employ a variety of imaging technologies, functioning on diverse ranges of wavelengths of the electromagnetic (EM) spectrum. For example, forward looking infrared (FLIR) is based on sensing infrared (IR) radiation, while radar is based on sensing microwave or radio wave radiation, and night vision devices (NVD) that amplify moonlight and starlight are based on sensing EM radiation in the visible part of the EM spectrum. Certain imaging technologies are more effective than others in providing improved imagery in different types of low visibility weather conditions. For example, FLIR is better suited for imaging through environmental obscurations resulting from haze than the above mentioned NVD. Furthermore, EVS typically employ multi-spectral image fusion, which combines images acquired from different spectral imaging sources into a single image. EVS and methods are known in the art.

U.S. Pat. No. 6,119,055 issued to Richman, entitled “Real Time Imaging System and Method for Use in Aiding a Landing Operation of an Aircraft in Obscured Weather Conditions” is directed to an apparatus and method for increasing the runway visual range of a pilot of an aircraft during the landing of the aircraft in inclement weather conditions that impair the view of the runway by the pilot. The apparatus includes a plurality of light emitting diode (LED) assemblies disposed on opposite sides of the runway, a radio frequency (RF) transmitter disposed on a tower near the end of the runway, and an imaging system, carried on board the aircraft. Each of the LED assemblies includes a plurality of LEDs, a current driver circuit, and a RF receiver. The imaging system includes an RF receiver, a processor, a camera, and a display. The RF transmitter transmits RF signals (i.e., synchronizing signals) to the RF receivers of each LED assembly, causing each corresponding driver circuit to energize the respective LEDs intermittently, at predetermined time durations. As the aircraft approaches the runway, the RF transmitter transmits the synchronization signals to the RF receiver of the imaging system. The camera and the LEDs are synchronized with the synchronization signals transmitted by the RF transmitter. The camera takes pairs of frames. The first frame includes radiant energy from the LEDs as well as radiant background energy from various sources besides the LEDs (e.g., arc lamps, and other lights sources on the ground). The camera takes the second frame when the LEDs are turned off. The processor receives the frames captured by the camera and subtracts (i.e., pixel by pixel) the digital information of the second frame from the digital information of the first frame. The display displays the resulting filtered images.

U.S. Patent Application Publication No.: US 2005/0232512 A1 by Luk et al., entitled “Neural Net Based Processor for Synthetic Vision Fusion” is directed to a synthetic vision fused integrated enhanced vision system (SVF IEVS) employing neural network processing. The system includes a sensor array, an association engine (AE), a database, and a head-up display and/or a head-down display (HUD/HDD). The AE includes a feature extraction mechanism, a registration mechanism, a memory, and an associative match mechanism. The associative match mechanism includes a best match processor (BMP), and an exact match processor (EMP). The sensor array includes a short wave infrared (SWIR) sensor, a long wave infrared (LWIR) sensor, and a millimeter wave (MMW) sensor, which are all connected to the AE. The LWIR sensor detects the thermal background, the SWIR sensor detects the runway lights, and the MMW sensor detects terrain background (i.e., by penetrating obscurations such as fog, and low clouds). The database stores a plurality of images of an objective (i.e., an approach to a runway). The database generates a plurality of training vectors (i.e., during a flight simulation or during multiple clear-weather approach flights), which create weights to be utilized by the BMP and EMP.

When the aircraft is landing in high visibility conditions, the feature extraction mechanism extracts features from the images that are captured by each of the sensors and generates the fused feature image of the objective, which is stored in the memory of the AE as a template vector. During system operation (e.g., in low visibility weather conditions) the registration mechanism compares the fused feature image with a database of expected features of the objective and provides registered sensor output vectors. The associative match mechanism compares the registered sensor output vectors with the database of images of the objective and generates comparison vectors for selecting an objective image for display. In particular, the BMP finds a best match by performing a comparison between the feature images with the database (i.e., training) images and generates an output vector, which is, in turn, input to the EMP. The EMP produces a pointer to the database of images, and a selected image is displayed on the HUD/HDD.

U.S. patent application No.: US 2007/0075244 A1 by Kerr, entitled “Enhanced Vision System Sensitive to Infrared Radiation” is directed to an enhanced vision system for use in the piloting of aircraft. The enhanced vision system includes a multi-detector head, a computer, and a display, which are all mounted in a forward section of an aircraft. Multi-detector head includes an electric light source imager, an ambient background scene imager, and a visible light imager. The multi-detector head and the display are connected with the computer. The ambient background scene imager includes an LWIR detector, and the visible light imager includes a charged-coupled device (CCD). The electric light source imager includes a spectral filter assembly, and an SWIR detector.

The electric light source imager and the ambient background scene imager are combined in an optical system that includes an optical lens, a dichoic beam splitter, a controllable iris, and a filter assembly. The electric light source imager senses infrared electromagnetic radiation from electric sources with the SWIR detector, and generates a video signal. The spectral filter assembly limits the radiation that is sensed by the SWIR detector. The ambient background scene imager senses infrared radiation from a background scene and also generates a video signal. The visible light imager senses visible light by the CCD, and generates an output signal, which is directed to the computer for processing. The visible light imager is used to verify whether the pilot is able to view the background scene without the enhanced vision provided by the electric light source imager and the ambient background scene imager. The computer combines the video signals generated by the electric light source imager and ambient background scene imager, by infrared image fusion to produce a fused image signal. The display displays the fused image signal.

U.S. Pat. No. 5,719,567 issued to Norris, and entitled “System for Enhanced Navigation and Surveillance in Low Visibility Conditions” is directed to a system for enhancing navigation and for providing the location of relevant objects, such as runway lights, in low visibility weather conditions. The system includes a plurality of ultraviolet radiation sources, a receiver, and a display. Each ultraviolet radiation source includes an ultraviolet lamp, beam forming optics, and a modulator. The ultraviolet lamps emit radiation in the ultraviolet part of the electromagnetic spectrum corresponding to a wavelength region of between ˜0.205 μm to 0.275 μm. The sources are positioned at or near visible beacons (i.e., runway lights). Each modulator in the ultraviolet radiation sources modulates the radiation generated by the ultraviolet lamps to form a recurring characteristic radiation pattern. The beam forming optics direct the ultraviolet radiation to within a particular solid angle of illumination. The ultraviolet radiation emanates from the ultraviolet radiation sources, propagates through low a visibility atmosphere, and is then received by the receiver, which is positioned on a vehicle, an aircraft, or a control tower.

The receiver includes a lens, an optical filter, an imaging tube, and a signal processor. The optical filter is a bandpass filter that allows through radiation having wavelengths of between 0.205 μm and 0.275 μm. The imaging tube is a “solar blind” micro-channel plate photomultiplier tube (MCP), which detects a radiant image by counting individual photons (emitted by the ultraviolet radiation sources) and registering their spatial relationship. Signal processor processes the images from the imaging tube, discerning between different kinds of modulated and unmodulated signals, and filters out undesirable unmodulated signals corresponding to signal sources such as those generated by street lamps. The receiver produces an image or representation of the received radiation, which is passed to the display. The display displays the image superimposed on a real-scene visible image.

### SUMMARY OF THE PRESENT DISCLOSED TECHNIQUE

It is an object of the disclosed technique to provide a novel apparatus and method for detecting airfield light emitters, which overcomes the disadvantages of the prior art. In accordance with the disclosed technique, there is thus provided an apparatus for detecting EM radiations emitted by airfield light emitters. The apparatus includes at least one light detection camera and a processor. Each light detection camera is coupled with the processor. At least one of the light detection cameras detects a plurality of respective wavebands of EM radiation within the EM spectrum. The light detection cameras produce respective spectral images. The processor produces a multispectral image of the airfield light emitters form the spectral images. The multispectral image includes a multi-dimensional set of spectral values. The processor further determines which combination in the multi-dimensional set of spectral values corresponds with a plurality of distinct light emission characteristics of the airfield light emitters, by identifying a particular spectral signature corresponding to the multi-dimensional set of spectral values. The processor produces an enhanced image from those spectral values of the multi-dimensional set of spectral values which correspond to the determined combination.

According to another aspect of the disclosed technique, there is thus provided a method for detecting airfield light emitters. The airfield light emitters have respective light emission characteristics. The method includes the procedures of acquiring a plurality of spectral images from EM radiation emitted from the airfield light emitters in a plurality of wavebands within the EM spectrum, generating a multispectral image of the airfield light emitters from the spectral images, and identifying a particular spectral signature of the airfield light emitters. Each spectral image corresponds to a particular one of the plurality of wavebands. The multispectral image includes a multi-dimensional set of spectral values. The particular spectral signatures of the airfield light emitters are identified from a combination of spectral values in the multi-dimensional set of spectral values corresponding to the respective light emission characteristics.

### BRIEF DESCRIPTION OF THE DRAWINGS

The disclosed technique will be understood and appreciated more fully from the following detailed description taken in conjunction with the drawings in which:

FIG. 1 is a schematic block diagram of a system, constructed and operative in accordance with an embodiment of the disclosed technique;

FIG. 2 illustrates a plurality of schematic plots, each depicting the spectral characteristics of different types of airfield light emitters within different types of atmospheric media;

FIG. 3 is a schematic diagram representing a spectral signature detection scheme based on a plurality of detectors, illustrating the dependency on particular atmospheric media;

FIG. 4 is a schematic block diagram illustrating the generation of an enhanced multi-spectral image; and

FIG. 5 is a schematic illustration of a method for detecting different types of airfield radiation emitters within different types of atmospheric media.

### DETAILED DESCRIPTION OF THE EMBODIMENTS

The disclosed technique overcomes the disadvantages of the prior art by providing a system and method for identifying environmentally modified spectral signatures of various types of airfield light emitters, using the combined operation of multiple waveband cameras to produce a multispectral image. Spectral values in a datacube of the multispectral image are analyzed to identify environmentally modified spectral signatures of known types of airfield radiation emitters (e.g., runway lights) within various types of atmospheric media (e.g., haze, clouds, fog).

A processor detects the environmentally modified spectral signatures present in the datacube corresponding to particular pixels in the multispectral image and compares them to corresponding spectral signatures stored in a database. The processor selects which particular features within the multispectral image are used to produce an enhanced image of the detected airfield radiation emitters. The processor fuses (i.e., combines) the multispectral image with a hyper-range image, acquired by a hyper-range camera, and a thermal image, acquired by a long-wave infrared (LWIR) camera to produce a fused image. The fused image is presented to the pilot.

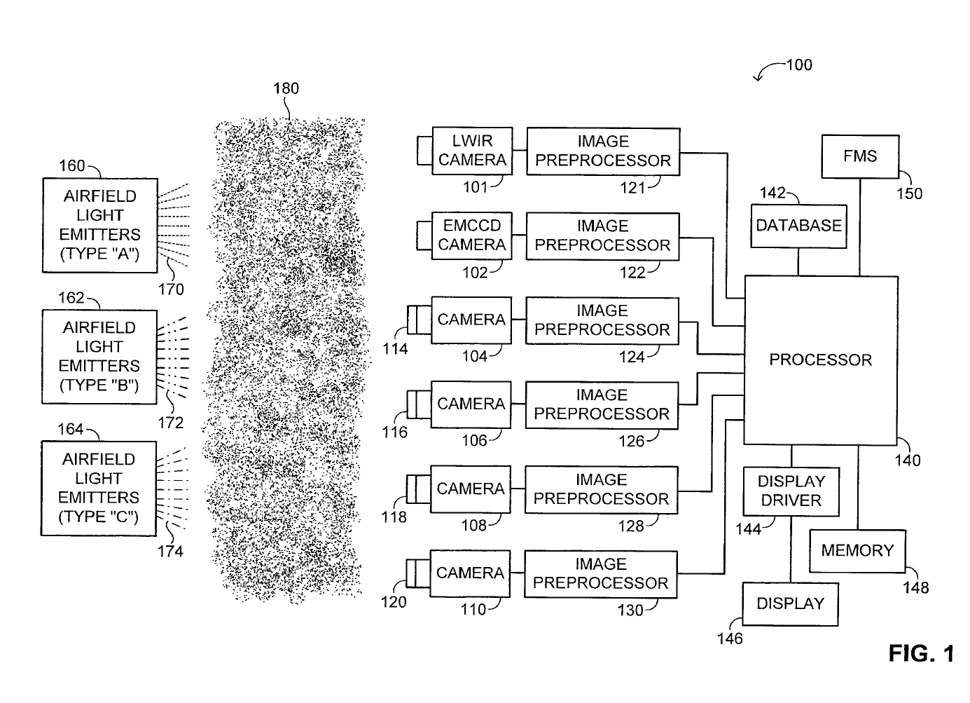

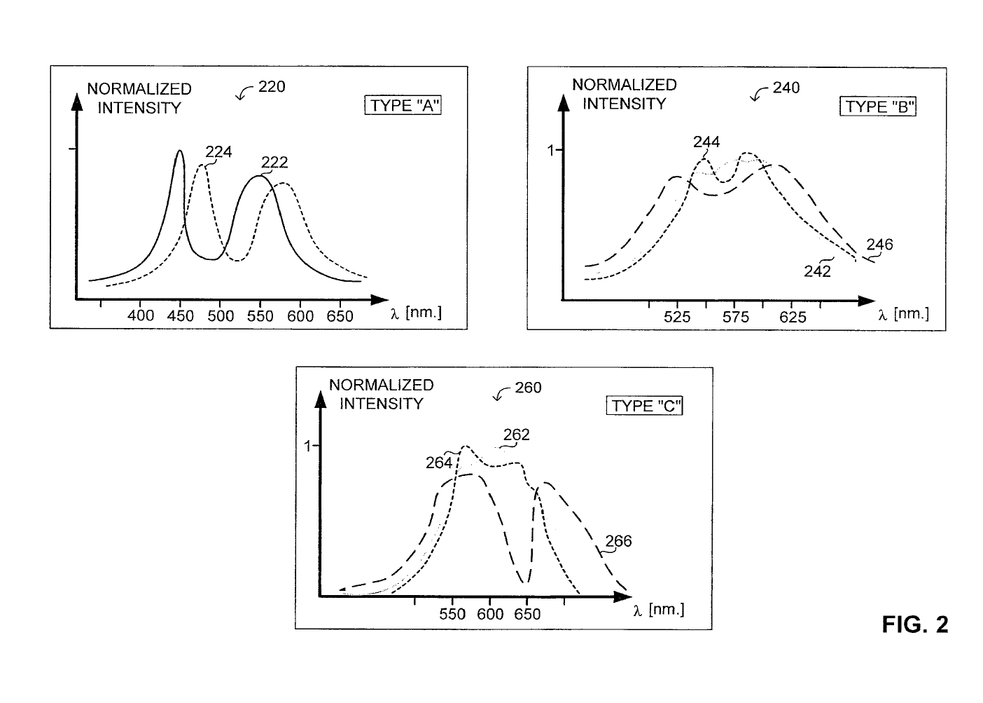

The terms “spectral band” and “waveband” are used herein interchangeably, and refer to a range or portion of the EM spectrum. Reference is now made to FIGS. 1 and 2. FIG. 1 is a schematic illustration of a system, generally referenced 100, constructed and operative in accordance with an embodiment of the disclosed technique. FIG. 2 illustrates a plurality of schematic plots, each depicting the spectral characteristics of different types of airfield light emitters within different types of atmospheric media. System 100 (FIG. 1) includes an LWIR camera 101, an electron-multiplying charge-coupled device (EMCCD) camera 102, a plurality of cameras, in particular, camera 104, camera 106, camera 108, and camera 110. System 100 is typically mounted within a cockpit (not shown) of an aircraft, with the exception of LWIR camera 101, which is typically mounted outside of the aircraft. The system further includes a plurality optical spectral filters 114, 116, 118, and 120, a plurality of image preprocessors 122, 124, 126, 128, and 130, a processor 140, a database 142, a display driver 144, a display 146, and a memory 148. Each camera (i.e., except for LWIR camera 101 and EMCCD camera 102) is optically coupled with its respective optical spectral filter and electronically coupled with its respective image preprocessor. Specifically, LWIR camera 101 is electronically coupled with image preprocessor 121, EMCCD camera 102 is electronically coupled with image preprocessor 122, camera 104 is optically coupled with optical spectral filter 114, and electronically coupled with image preprocessor 124. camera 106 is optically coupled with optical spectral filter 116 and electronically coupled with image preprocessor 126. camera 108 is optically coupled optical spectral filter 118 and electronically coupled with image preprocessor 128, and camera 110 is optically coupled optical spectral filter 120 and electronically coupled with image preprocessor 130. Each one of the cameras, coupled with its respective image preprocessor, represents a “channel”. Processor 140 is coupled with image preprocessors 121, 122, 124, 126, 128, and 130, database 142, display driver 144, memory 148, and with a flight management system (FMS) 150 of the aircraft. Display driver 144 is coupled with display 146. EMCCD camera 102 and cameras 102, 104, 106, 108, and 110 are mounted within the cockpit of the aircraft (not shown), whereas LWIR camera 101 is typically mounted outside of the cockpit, whereby all cameras are arranged at such positions and orientations as to enable the visualization of airfield runways during the approach to landing of the aircraft.

Different airport runways may employ different types of runway lighting systems. FIG. 1 illustrates three types of airfield light emitters each of different type, airfield light emitters 160 of type “A”, airfield light emitters 162 of type “B”, airfield light emitters 164 of type “C”. Airfield light emitters 160, 162, and 164 are employed approach landing system (ALS) lights, such as airfield runway edge lights, typically located along the length of the runways of airports. Alternatively, airfield light emitters 160, 162, and 164 can also be employed in runway centerline lights, visual approach slope indicator (VASI) lights, precision approach path indicator (PAPI) lights, runway end identifier lights (REIL), touchdown zone lights (TDZL), and the like. Airfield light emitters 160 emit EM radiation 170, airfield light emitters 162 emit EM radiation 172, and airfield light emitters 164 emit EM radiation 174.

Each type of airfield light emitter emits EM radiation (e.g., visible light, infrared light, ultraviolet light) over a plurality of distinct spectral bands (i.e., possesses particular spectral emission characteristics). With reference to FIG. 2, a plurality of schematic plots are depicted, each of which illustrate the spectral characteristics of a particular type of airfield light emitter within different types of atmospheric media. In particular, schematic plot 220 corresponds to that of airfield light emitters 160 of type “A”, schematic plot 240 corresponds to that of airfield light emitters 162 of type “B”, and schematic plot 260 corresponds to that of airfield light emitters 164 of type “C”. The axis of the abscissas of each of schematic plots 220, 240, and 260 represents the wavelength of the spectral emission in units of nanometers. The axis of ordinates of each of schematic plots 220, 240, and 260 represents the normalized intensity of the respective spectral emissions.

Airfield light emitters 160 of type “A” are selected to be of white light emitting diode (LED) type. The spectral emission characteristics associated with EM radiation 170 are represented by spectral emission characteristic 222, indicated by a solid continuous line in schematic plot 220. Airfield light emitters 162 of type “B” of are selected to be of incandescent type. The spectral emission characteristics associated with EM radiation 172 are represented by spectral emission characteristic 242, indicated by a solid continuous line in schematic plot 240. Airfield light emitters 164 of type “C” are selected to be of halogen incandescent type. The spectral emission characteristics associated with EM radiation 174 are represented by spectral emission characteristic 262, indicated by a solid continuous line in schematic plot 260. The above selection corresponds to the three typical types of airfield light emitters that are utilized, it is stressed, however, that the disclosed technique is not bound nor limited to a particular type of airfield light emitter, and the above selection is made for the purposes of elucidating the disclosed technique through the use of example. Other types of airfield light emitters include, for example, those of gas discharge type, arc type, laser type, sulfur type, metal halide type, LEDs, and the like, all of which may emit light of different colors (e.g., blue, red, green).

When an aircraft employing system 100 approaches a runway for landing (not shown), airfield light emitters 160, 162, and 164, and the aircraft are in an environment which is surrounded by an atmospheric medium 180, such as air. FIG. 1 illustrates a simplified representation of atmospheric medium 180, through which EM radiations 170, 172, and 174 propagate. Atmospheric medium 180 and the optical characteristics thereof (e.g., transmissivity, reflectivity) are dependent on the specific environmental conditions. Atmospheric medium 180 can be, for example, atmospheric dust, rain drops, ice crystals, snow crystals, smog, haze, water clouds and fogs, condensation nuclei, hailstones, a variety of pollens, drizzle, sea salt nuclei, oil smokes, and the like. It is noted that atmospheric medium 180 can inherently ensue from a combination of atmospheric phenomena, each possessing a variety of atmospheric constituents.

According to EM wave theory, certain characteristics of EM radiations 170, 172, and 174 may change when propagating through atmospheric medium 180. For example, according to Beer-Lambert-Bouguer law, part of the EM light radiation may be absorbed by the medium through which it is traveling. The amount of absorption depends on various variables, such as the type of the medium, and the optical thickness. Furthermore, EM radiations 170, 172, and 174 propagating through atmospheric medium 180 are subject to the effects of scattering such as Rayleigh scattering (i.e., occurring when light scatters off the molecules or particles in the air, approximately up to a tenth of the wavelength of the light) and Mie scattering (i.e., occurring when light scatters off larger molecules, such as aerosols and particulates). If the EM radiations scatter off atmospheric medium 180 predominately due to Mie scattering, (i.e., inelastic scattering), EM radiations 170, 172, and 174 are each changed in wavelength from each of those which were emitted, respectively, due to the wavelength dependence of scattering. Therefore, a decrease in radiant intensity (i.e., attenuation) in the amplitude of each of EM radiations 170, 172, and 174, and changes in the wavelengths, may occur as a result of absorption and scattering from atmospheric media 180.

Generally, EM radiation is scattered and absorbed differently while interacting with different types of atmospheric media 180. For example, the scattering from atmospheric medium 180, composed essentially from fog droplets, is substantially independent of wavelength (i.e., over the visible part of the EM spectrum), while the scattering from oil droplets is substantially dependent of wavelength. The different types of atmospheric media 180 may hereby be denoted via the designations “type I”, “type II”, “type III”, and so forth. For example, atmospheric medium 180, of type I, consists, in essence, from dust particles, whereas atmospheric medium 180 of type II consists, in essence, from snow crystals. Spectral characteristic 224, in schematic plot 220 (FIG. 2), denoted by a dotted line, represents the spectral characteristics of airfield light emitters 160 (FIG. 1) of type “A” when detected through a particular type (i.e., type I) of atmospheric medium 180 possessing known properties (e.g., such as the refractive index) and under known environmental conditions (e.g., such as pressure, temperature, optical thickness). In a comparison between spectral emission characteristic 222 and spectral characteristic 224, it is evident that the latter is different with respect to the former. This phenomenon occurs as a result of the interaction of EM radiation 170 with atmospheric medium 180. Spectral characteristic 224 is shifted and also attenuated with respect to spectral emission characteristic 222. In particular, the two dominant peaks in spectral emission characteristic 222, occurring at approximately 450 and 550 nanometers are shifted to approximately 475 and 575 nanometers, respectively, as depicted in spectral characteristic 224.

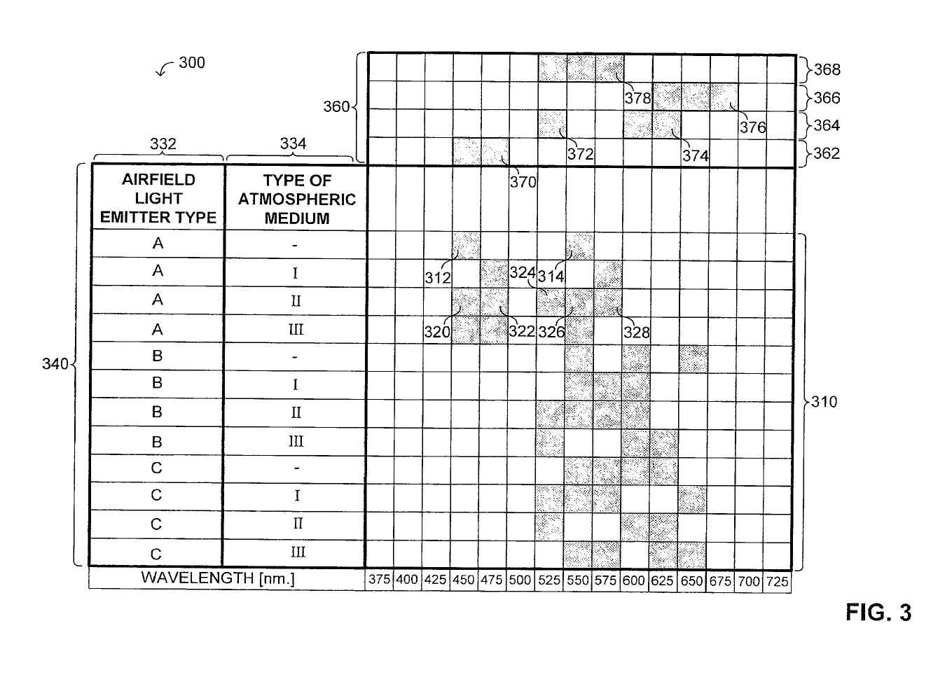

In an analogous manner, FIG. 2 illustrates that spectral characteristic 244, in schematic plot 240, which is denoted by a dotted line, represents the spectral characteristics of airfield light emitters 162 (FIG. 1) of type “B” when detected through a particular type (i.e., type I) of atmospheric medium 180 under known environmental conditions. Spectral characteristic 246, also in schematic plot 240, denoted by a dashed line, represents the spectral characteristics of airfield light emitters 162 when detected through atmospheric medium 180 of type III. Spectral characteristic 264, in schematic plot 260, which is denoted by a dotted line, represents the spectral characteristics of airfield light emitters 164 (FIG. 1) of type “C” when detected through atmospheric medium 180 of type III under know environmental conditions. Spectral characteristic 266, also present in schematic plot 260, denoted by a dashed line, represents the spectral characteristics of airfield light emitters 164 when detected through atmospheric medium 180 of type IV (not shown in the schematic diagram of FIG. 3).

System 100 has different modes of operation. According to one mode of operation, as will be described in detail below, system 100 detects EM radiation emanating from the airfield light emitters which has been modified as a result of the environment. In particular, system 100 detects EM radiations 170, 172, and 174 through atmospheric medium 180 in its myriad forms (i.e., spatial formations), constituents (i.e., chemical compositions) and manifestations (i.e., dynamics). EMCCD camera 102 is a high sensitivity, high speed imaging detector employing amplification, which produces images (not shown) of a scene (not shown) with a field of view (FOV) comparable with that, which has a pilot, gazing through the windshield or canopy of the aircraft (not shown). EMCCD camera 102 is a relatively wide spectrum camera (i.e., referred hereinafter as hyper-range), operative to sense EM radiation within the visible and near infrared (NIR) regions of the EM spectrum. In other words, EMCCD camera 102 acquires a hyper-range image of the external scene. Alternatively, EMCCD camera 102 is operative to sense other regions within the EM spectrum, such as ultraviolet (UV), short-wavelength infrared (SWIR), and the like. Further alternatively, EMCCD camera 102 can be substituted by other types of light intensifying cameras, each type employing different light intensifying techniques, such as those employed, for example, in NVDs, in active pixel sensors (APS), and the like. LWIR camera 101 acquires an infrared image (i.e., a thermal image in the thermal region of 8-15 μm) of the external scene. The acquired infrared image of the external scene may include the airfield light emitters, the runway, and the background, such as in settings involving approach for landing of the aircraft. The runway, background, and airfield light emitters typically exhibit different thermal emission characteristics that may consequently facilitate detection thereof by the cameras. In particular, LWIR camera 101 is operative to detect the runway in low visibility conditions as well as to enhance situational awareness of the pilot, in general.

Each one of the cameras (i.e., camera 104, camera 106, camera 108, and camera 110) is a camera operative to sense EM radiation in a particular region of interest (ROI) within the EM spectrum, and to produce images (not shown), accordingly. Each one of the cameras may employ CCD sensors, complementary metal oxide semiconductors (CMOS) sensors, indium gallium arsenic (InGaAs) based sensors, mercury cadmium telluride (MCT) based sensors, quantum well infrared photodetectors (QWIPs), indium antimonide (InSb) based sensors, microbolometer (μB) type sensors, combinations thereof, and the like. Alternatively, one or more cameras can each be operative to sense EM radiation in a plurality of wavebands (i.e., continuous, or discontinuous spectral bands) within the EM spectrum. Further alternatively, each camera can be constructed from elements which are sensitive to different spectral bands within the EM spectrum (i.e., each camera is characterized by a different spectral response curve).

Each one of the optical spectral filters (i.e., optical spectral filter 114, optical spectral filter 116, optical spectral filter 118, and optical spectral filter 120) determines the ROI for each respective camera (i.e., the filters are associated with particular wavebands). Each one of the optical spectral filters is an optical band-pass filter that filters out substantially all wavelengths of EM radiation except for wavelengths in a particular range within the ROI. Alternatively, one or more of the optical spectral filters is an optical multi-band-pass filter, operative to filter out substantially all wavelengths of EM radiation, except for wavelengths from a plurality of respective spectral bands within the ROI. Further alternatively, each one of the optical spectral filters can be implemented in in an interchangeable filter configuration, such as, for example, in a filter wheel (not shown). Further alternatively, each one of the optical spectral filters can be implemented using microelectromechanical systems (MEMS). It is noted that some cockpit windshields in some aircraft may incorporate filters to block particular spectral bands of the EM spectrum. System 100 takes into account the various optical filtering characteristics of these cockpit windshields.

The combined operation of camera 104, camera 106, camera 108, and camera 110 and their respective optical spectral filters is utilized to produce a multispectral image employed for the process of optimizing the recognition of the specific spectral emission characteristics of EM radiation, detected by these cameras, radiated from the different types of airfield light emitters. The multispectral image is composed from a datacube (not shown), consisting of a multi-dimensional array of data (i.e., a multi-dimensional set of spectral values).

Each pixel (i.e., a “hyper-pixel”) in the multispectral image is effectively, a multi-dimensional array of spectral data. Moreover, these cameras with their respective optical spectral filters are further utilized for the process of optimizing the recognition of the spectral characteristics of these radiations through different types of atmospheric media 180. These particular spectral characteristics typically contain “spectral signatures”. A spectral signature is a particular wavelength or combination of wavelengths of EM radiation, which can uniquely identify an object. For example, the spectral signature comprising the two dominant peaks in spectral emission characteristic 222, occurring at approximately 450 and 550 nanometers are employed to uniquely identify the type of source emitting the EM radiation (i.e., which in this case, is of type A″). Database 142 stores a plurality of unique spectral signatures of EM radiation 170, 172, and 174. Database 142 further stores a plurality of unique modified spectral signatures of EM radiation 170, 172, 174, as modified by different types of atmospheric media 180.

Reference is now further made to FIG. 3, which is a schematic diagram, generally referenced 300, representing a spectral signature detection scheme based on a plurality of detectors, illustrating the dependency on particular atmospheric media. It is noted that FIG. 3 represents only an example of a particular aspect of operation of the disclosed technique. This particular aspect of operation is described in terms and principles corresponding to those employed in finite state machines (FSM). It is stressed, however, that this particular aspect of operation is not limited by this particular type of representation, or any so other types of representations.

The schematic diagram in FIG. 3 includes three main sectors, data sector 310, source sector 340, and detection sector 360. Each of the sectors is sub-divided into a plurality of rows and a plurality of columns, thus forming grids. Data sector 310 is a representation of a multi-dimensional data set. Source sector 340 includes column 332 and column 334. Detection sector 360 includes row 362, row 364, row 366, and row 368. Column 332 tabulates different types of airfield light emitters (i.e., of types “A”, “B”, and “C”). Column 334 tabulates various types of atmospheric media 180 (i.e., of types I, II, III, and so forth).

The different rows in data sector 310 represent distribution of particular spectral characteristics (e.g., dominant spectral lines, spectral peaks) of the EM radiation of types “A”, “B”, and “C” of airfield light emitters in types I, II, III, of atmospheric media 180, as a function of the wavelength of the EM radiation, which is represented by the different columns. The wavelength is expressed in units of nanometers. Therefore, a shaded square in the grid of data sector 310 indicates that a particular type of airfield light emitter in a particular type of atmospheric medium 180 possesses particular spectral features at specific wavelengths. For example, FIG. 3 illustrates that the EM radiation emitted by airfield light emitter 160 of type “A” possesses dominant spectral peaks at wavelengths of 450 and 550 nanometers, independent of atmospheric media 180. However, in the presence of an atmospheric medium 180 of type II, the detected EM radiation from airfield light emitters 160 possesses dominant spectral peaks at wavelengths of 450, 475, 525, 550, and 575 nanometers.

Therefore, in consideration with the simplified example above, the detection of dominant spectral peaks at 450 and 525 nanometers in the absence of an atmospheric medium 180 would indicate a spectral signature corresponding to airfield light emitters 160 of type “A”. This spectral signature would consist of a dominant spectral peak 312, and a dominant spectral peak 314. The detection of dominant spectral peaks at wavelengths of 450, 475, 525, 550, and 575 nanometers would indicate a modified spectral signature corresponding to airfield light emitters 160 of type “A” in the presence of atmospheric medium 180 of type II. This modified spectral signature (i.e., modified by atmospheric medium 180 of type II) would consist of a dominant spectral peak 320, a dominant spectral peak 322, a dominant spectral peak 324, a dominant spectral peak 326, and a dominant spectral peak 328.

Database 142 (FIG. 1) stores a plurality of these unique spectral signatures and modified spectral signatures of the EM radiation radiated from different types of airfield light emitters 170, 172, and 174, and different types of atmospheric media 180, as represented by data sector 310. It is noted that although the representations of the spectral peaks within data sector 310 are indicated by identical monochromatically shaded squares, database 142 typically assigns different values to each square, representing the different intensity values of the spectral characteristics. It is further noted that database 142 takes into account additional parameters (not shown in FIG. 3) such as the influence of temperature, pressure, optical thickness, altitude of the aircraft, and the like.

Detection sector 360 illustrates a simplified representation of the spectral response of each of the cameras with their respective optical spectral filters, as a function of the wavelength. Row 362 illustrates the spectral response of camera 104 (FIG. 1) operative with optical spectral filter 114 (FIG. 1) to detect EM radiation, as a function of the wavelength. Therefore, according to detection sector 360, camera 104 and spectral filter 114 possess the ability to detect EM radiation in a spectral detection band 370, which lies substantially between 450 and 475 nanometers. Camera 104 detects EM radiation within spectral detection band 370, impinging thereon, provided the EM radiation being of sufficient intensity, and produces an image (not shown), accordingly. In a similar manner, row 364 illustrates the spectral response of camera 106 operative with optical spectral filter 116 to detect EM radiation, as a function of the wavelength, hence camera 106 and spectral filter 116 possess the ability to detect EM radiation in dual spectral detection bands, namely, a spectral detection band 372 and a spectral detection band 374. Camera 106 detects EM radiation within spectral detection bands 372 and 374, impinging thereon, provided the EM radiation being of sufficient intensity, and produces an image (not shown), accordingly. Row 366 illustrates the spectral response of camera 108 operative with optical spectral filter 118 to detect EM radiation, as a function of the wavelength. camera 108 and spectral filter 118 possess the ability to detect EM radiation in a spectral detection band 376. Camera 108 detects EM radiation within spectral detection band 376, impinging thereon, provided the EM radiation being of sufficient intensity, and produces an image (not shown), accordingly. Row 368 illustrates the spectral response of camera 110 operative with optical spectral filter 120 to detect EM radiation, as a function of the wavelength, therefore, camera 110 and spectral filter 120 possess the ability to detect EM radiation in a spectral detection band 378. Camera 110 detects EM radiation within spectral detection band 378, impinging thereon, provided the EM radiation being of sufficient intensity, and produces an image (not shown), accordingly. It is noted that different spectral detection bands from different cameras may partially overlap, such as in the case of spectral detection band 374 and spectral detection band 376.

In order to detect the spectral signature of a particular type of airfield light emitter, through a particular type of atmospheric medium 180, the combined operation of the cameras and their respective optical spectral filters is employed. Nonetheless, a situation where only one of cameras 104, 106, 108 and 110 is required for this purpose is also possible. For example, camera 104 with optical spectral filter 114, and camera 110 with optical spectral filter 120 are both required to detect the spectral signature corresponding to the EM radiation radiated by airfield light emitters 160 of type “A” through atmospheric medium 180 of type III. In another example, in order to detect the spectral signature corresponding to the EM radiation radiated by airfield light emitter 164 of type “C” through atmospheric medium 180 of type II, only one camera is required, namely, camera 106 with optical spectral filter 116. Nevertheless, system 100, may employ two more cameras, namely camera 104 with optical spectral filter 114 and camera 110 with optical spectral filter 120, to enhance detection in regions where the spectral detection bands of the different cameras overlap, such as spectral detection band 372 with spectral detection band 378 at 525 nanometers, and spectral detection band 374 with spectral detection band 376 at 625 nanometers. Hence, processor 140 may determine the type of airfield light emitter whose radiation is detected by the cameras through various types of atmospheric media, according to the spectral signature that is exhibited.

According to another embodiment of the disclosed technique the system includes a single camera, which is optically coupled with a plurality of optical filters, implemented by an interchangeable filter configuration, such as in a filter wheel (not shown). In such an alternative operation, the filter wheel rotates, while the camera acquires a plurality of images (not shown) each through a different optical filter of the filter wheel. When a single camera is employed, it is typically coupled inside of the cockpit of the aircraft.

Each of image preprocessors 121, 122, 124, 126, 128, and 130 (FIG. 1) preprocesses each of the respective images, which are outputted from their respective camera (i.e., LWIR camera 101, EMCCD camera 102, camera 104, camera 106, camera 108, and camera 110, respectively), prior to being each processed by processor 140, and produce preprocessed images. Image preprocessors 121, 122, 124, 128 and 130 initially subdivide each of these outputted images from each respective camera into blocks, which are preprocessed independently by the respective image preprocessor. For instance, an image with a resolution of 1000×1000 pixels may be partitioned into ten non-overlapping blocks of 100×100 pixels. A special case where the image constitutes a single block is also viable. Image preprocessors 121, 122, 124, 126, 128 and 130 employ techniques of digital image processing, such as feature extraction (e.g., extracting the features, such as pixel data relating to the position and intensity of the airfield light emitters within the images), homomorphic filtering for image enhancement, signal-to-noise (SNR) enhancement algorithms (i.e., for the enhancement of the images), and the like. Processor 140 processes the preprocessed images and employs multi-spectral algorithms. In particular, processor 140 determines which a combination (not shown) of spectral values of the multi-dimensional set of spectral values corresponds with distinct light emission characteristics of the airfield light emitters, by identifying a particular spectral signature corresponding to the multi-dimensional set of spectral values. Processor 140 then produces an enhanced image from those multi-dimensional set of spectral values corresponding to the determined combination.

Processor 140 is operative to detect local peaks (i.e., maxima in pixel intensity values) in the preprocessed images in order to facilitate identification of the airfield light emitters within the images. Processor 140 employs other digital image processing techniques, which include thresholding techniques, time integration techniques, spatial high pass (HP) filtering, pattern recognition techniques including peak (light) pattern recognition, and the like. Pattern recognition techniques can include straight line pattern recognition, and circle pattern recognition for identifying the airfield light emitters, according to the total number of the detected airfield light emitters, as well as the mutual distances there between. Information regarding the characteristics of the airfield light emitters that are employed in airports can be found, for example in the U.S. Federal Aviation Administration (FAA) “Specification for Runway and Taxiway Light Fixtures” (AC No.: 150/5345-46), and in other related documents.

Database 142 stores the plurality of unique spectral signatures of EM radiation 170, 172, and 174 from different types of airfield light emitters employed at different airports around the world. In certain cases, however, database 142 might not have a unique spectral signature from a particular type of airfield light emitter, corresponding to the EM radiation detected by one or a combination of cameras 102, 104, 106, and 108. In this mode of operation, system 100 (FIG. 1) will still be able to function (i.e., to produce an enhanced image of the detected airfield radiation emitters), by employing digital image processing techniques (e.g., pattern recognition). For example, system 100 can employ analytical techniques in order to identify the spectral signatures of the airfield radiation emitters. Processor 140 can be programmed to search and to identify dominant peaks in the spectral emission characteristics of the airfield light emitters, according to an algorithm, an analytic formula, and the like. For example, processor 140 can be programmed to identify two dominant peaks, which are distanced apart along the EM spectrum by 34 nanometers, corresponding to a particular type of airfield light emitter through a particular type of atmospheric medium. Processor 140 is further operative to identify and differentiate between various features in the images (e.g., enhanced image, hyper-range image, thermal image), such as the airfield light emitters, the background, and the runway, according to distinct spectral emission characteristics that each exhibit. Database 142 may further store a plurality of spectral emission characteristics of different runways (e.g., made of concrete, asphalt, grass, ice), and the approach for landing settings (e.g., backgrounds) of various airports (i.e., taking into account, for example, the elevation and ambient external temperature). Once the airfield light emitters are identified in the images, they may be highlighted, for example through false-color and pseudo-color schemes, delineation methods, and the like. Alternatively, the background and the runway may be highlighted in the images, in relation to the airfield light emitters.

FMS 150 provides processor 140 with information regarding the position and bearing of the aircraft relative to a ground target (e.g., elevation, range from the runway). The elevation of the aircraft as well as the range from the runway can be used to estimate the optical thickness of atmospheric medium 180 (i.e., in real-time). Consequently, this is used in a calculation by processor 140 to estimate the wavelength dependence on the scattering of the EM radiations as a function of the current optical thickness of atmospheric medium 180. It is noted that system 100 can operate without requiring the use of FMS 150 of the aircraft (i.e., as a standalone system).

System 100 may employ image saturation management techniques, an example of which is given herein below. The phenomenon of saturation (i.e., or purity, the degree of difference from gray possessing the same lightness) can occur when an acquired image is overexposed, typically when the entire image, or a part thereof, exceeds the dynamic range of the camera that acquired the image. When one or more of LWIR camera 101, EMCCD camera 102, camera 104, camera 116, camera 118, and camera 120 acquires a saturated image (not shown), processor 140 executes an automatic gain for saturation control (AGSC) algorithm, in order to control (e.g., reduce, minimize, eliminate) the effect of saturation. For example, processor 140, running the AGSC algorithm, can lower the gain (i.e., the level of amplification) of a particular camera in order to eliminate the effect of saturation in the images acquired by this camera.

In particular, as long as a certain saturation threshold value of a particular image, acquired from a particular camera, is not exceeded, processor 140 maintains a substantially high level of gain for that camera, in order to attain high expectation values for an image histogram (not shown) of that particular image. The saturation threshold value defines a value, substantially beyond which the effect of saturation of a particular image is substantially evident. An example of image saturation management is given below in Table 1.

TABLE 1
An example of image saturation management

| | Expectation values of the | | |
|---|---|---|---|
| | image histogram | | |
| Saturation level | Low | Nominal | High |
| Threshold value exceeded | decrease | decrease | decrease |
| | amplification | amplification | amplification |
| Nominal | maintain | maintain | decrease |
| | same | same | amplification |
| | amplification | amplification | |
| Low | Increase | maintain | decrease |
| | amplification | same | amplification |
| | | amplification | |

Table 1 illustrates, for example, that if a particular camera acquires an image having a saturation level that exceeds the threshold value while the expectation values of the image histogram of that image are low, processor 140, running the AGSC algorithm, decreases the amplification of that camera. If on the other hand, a particular camera acquires an image having a nominal saturation level (i.e., within a range of nominal saturation levels) while the expectation values of the image histogram of that image are low, processor 140 maintains the same level of amplification to that camera. It is further noted that system 100 can further employ histogram equalization techniques. It is noted that image saturation management may be implemented on individual blocks of partitioned images.

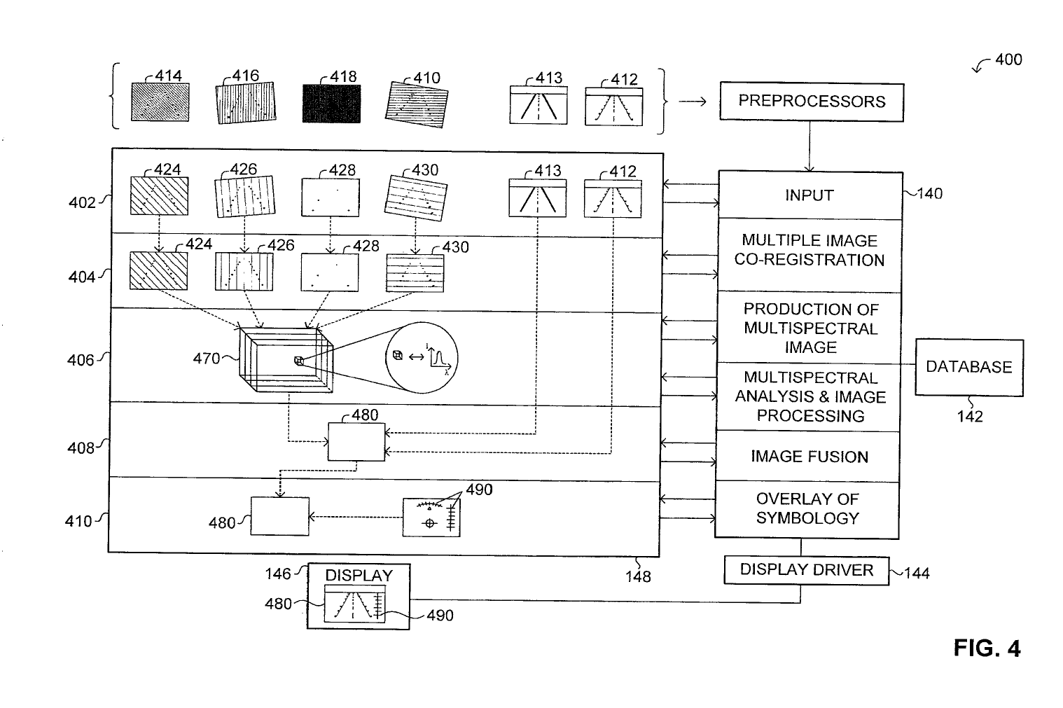

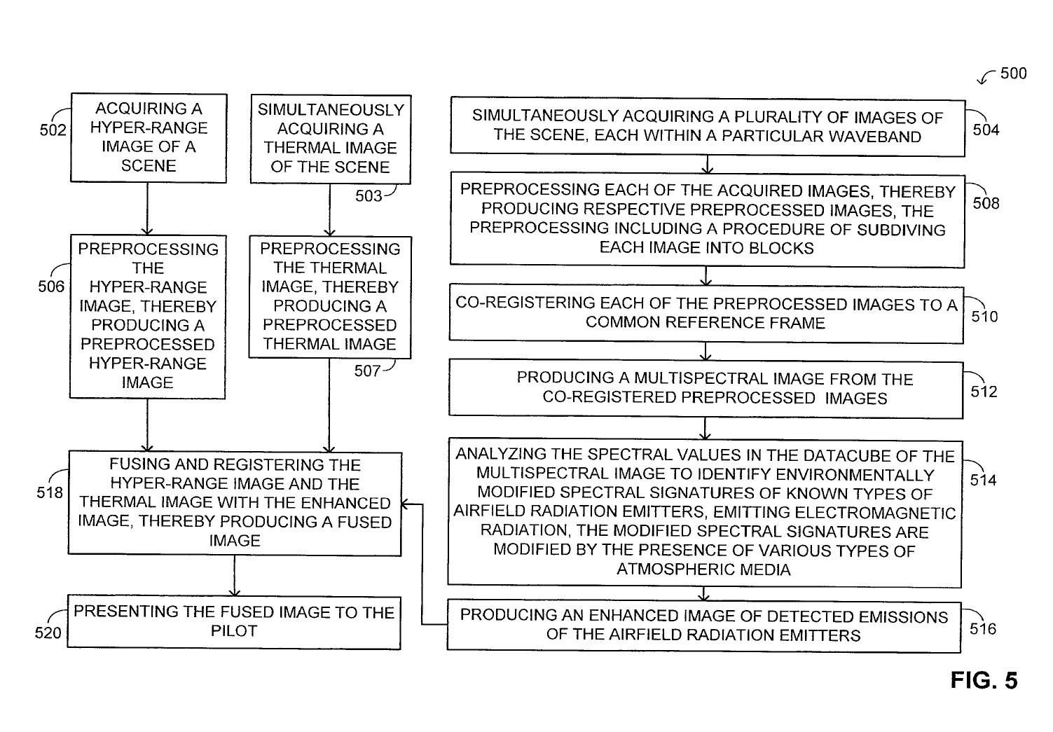

Reference is now further made to FIGS. 4 and 5. FIG. 4 is a schematic block diagram, generally referenced 400, illustrating the generation of an enhanced image. FIG. 5 is a schematic illustration of a method, generally referenced 500, for detecting different types of airfield radiation emitters within different types of atmospheric media. FIG. 4 depicts illustrative representations of the various processes (i.e., stage 402, stage 404, stage 406, stage 408, and stage 410) of memory 148 of system 100 (FIG. 1) at different instants of operation.

In procedure 502, a hyper-range image of a scene is acquired. With reference to FIGS. 1 and 4, EMCCD camera 102 (FIG. 1) acquires a hyper-range image 412 (FIG. 4) of a scene through the cockpit window (i.e., canopy, windshield) of the aircraft.

In procedure 503, a thermal image of the scene is acquired simultaneously (with hyper-range image 412). With reference to FIGS. 1 and 4, LWIR camera 101 (FIG. 1) acquires a thermal (i.e., long wave infrared) image 413 (FIG. 4) of the scene from outside of the cockpit of the aircraft.

In procedure 504, a plurality of images of the scene are simultaneously acquired, each image being within a particular waveband. With reference to FIGS. 1 and 4, camera 104, camera 106, camera 108, and camera 110 (FIG. 1) each simultaneously acquire a plurality of images 414, 416, 418, 418, and 420 (FIG. 4), respectively, of the scene. These acquired images are from the scene that includes airfield light emitters 160, 162, and 164 (emitting EM radiations 170, 172, 174, respectively). It is noted that at least one acquired image corresponds to a particular one of the wavebands of airfield light emitters 160, 162, 164. It is further noted that procedures 502 and 504 may be executed simultaneously.

In procedure 506, the hyper-range image is preprocessed, thereby producing a preprocessed hyper-range image. With reference to FIGS. 1 and 4, image preprocessor 122 (FIG. 1) preprocesses hyper-range image 412 (FIG. 4). Preprocessing may further include a preliminary procedure of subdividing hyper-range image 412 into blocks and preprocessing each block individually.

In procedure 507, the thermal image is preprocessed, thereby producing a preprocessed thermal image. With reference to FIGS. 1 and 4, image preprocessor 121 (FIG. 1) preprocesses thermal image 413 (FIG. 4). Preprocessing may further include a preliminary procedure of subdividing thermal image 413 into blocks and preprocessing each block individually.

In procedure 508, each of the acquired images is preprocessed, thereby producing respective preprocessed images, the preprocessing including a procedure of subdividing each image into blocks. With reference to FIGS. 1 and 4, image preprocessors 124, 126, 128, and 130 (FIG. 1) each preprocess the image acquired by camera 104, camera 106, camera 108, and camera 110, respectively, thereby producing respective preprocessed images 424, 426, 428, and 430. In stage 402, memory 148 receives via processor 140, preprocessed image 424 from image preprocessor 124, preprocessed image 426 from image preprocessor 126, preprocessed image 428 from image preprocessor 128, preprocessed image 430 from image preprocessor 130, and preprocessed hyper-range image 412, from image preprocessor 122.

In procedure 510, the preprocessed images are co-registered to a common reference frame. With reference to FIGS. 1 and 4, processor 140 co-registers each of preprocessed images 424, 426, 428, and 430 into a common reference frame, in order to align the images taken from different viewpoints within the cockpit, so that all the corresponding points in each of the respective preprocessed images match. Memory 148 receives at stage 404, preprocessed images 424, 426, 428, and 430 which are co-registered.

In procedure 512, a multispectral image is produced from the co-registered preprocessed images. With reference to FIGS. 1 and 4, processor 140 produces multispectral image 470 from preprocessed images 424, 426, 428, and 430, which are preprocessed and co-registered. Memory 148 receives multispectral image 470 in stage 406. Multispectral image 470 (i.e., of the scene that includes airfield light emitters 160, 162, and 164) includes a multi-dimensional set of spectral values (not shown).

In procedure 514 the spectral values in the datacube of the multispectral image are analyzed to identify environmentally modified spectral signatures of known types of airfield radiation emitters, emitting EM radiation, the modified spectral signatures are modified in the presence of various types of atmospheric media. Particularly, with reference to FIG. 1, spectral signatures of airfield light emitters 160, 162, and 164 are identified from a combination (not shown) of spectral values in the multi-dimensional set of spectral values corresponding to the respective light emission characteristics of the airfield light emitters. Processor 140 compares spectral values in the datacube with spectral signatures stored in database 142. It is noted that spectral signatures that have not been environmentally modified can also be identified. It is further noted that in procedure 514, image processing techniques are employed in order to identify features in the multispectral image (e.g., the airfield light emitters), such as, peak detection, histogram equalization, and the like.

In procedure 516, an enhanced image of the detected emission of the airfield radiation emitters is produced. Particularly, the enhanced image is produced according to those spectral values in the multi-dimensional set of spectral values corresponding to the combination. The procedure involves the detection and recognition of only EM radiation, which is emitted by a particular type of airfield light emitter through a particular type of atmospheric medium, characterized by specific spectral characteristics, while rejecting undesirables, such as noise, which is characterized by other characteristics. With reference to FIGS. 1, 3, and 4, processor 140 compares every pixel in the datacube of multispectral image 470, containing detected values of illumination (i.e., possessing particular characteristics) with corresponding values in database 142. Processor 140 identifies which of cameras 114, 116, 118, and 120 are involved in the detection of the particular type of airfield light emitter through a particular type of atmospheric medium, from the individual contributions of corresponding respective images 424, 426, 428, and 430 that make up multispectral image 470, according to the spectral signature detection scheme described in FIG. 3. If particular features (i.e., or combination thereof), such as spectral signatures present in datacube corresponding to a particular pixel in multispectral image 470) in the possess characteristics that match the corresponding spectral signatures in database 142, then these features are constructively combined by processor 140 in order to enhance these features. Processor 140 produces an enhanced image 480 from these features. Conversely, features that do not match the spectral signatures in database 142 are marked as noise and the corresponding pixel data within the datacube of multispectral image 470 are rejected from enhanced image 480.

In procedure 518, the hyper-range image and the thermal image are registered and fused with the enhanced image, thereby producing a fused image. With reference to FIGS. 1 and 4, processor 140 (FIG. 1) fuses hyper-range image 412 and thermal image 413 (FIG. 4), with enhanced image 470, and produces a fused image 480. Memory 148 receives fused image 480 from processor 140 at stage 408. In an alternative procedure, either the hyper-range image or the thermal image is registered and fused with the enhanced image to produce the fused image.

In procedure 520 the fused image is presented to the pilot. With reference to FIGS. 1 and 4, display driver 144 receives fused image 480 from processor 140, and directs display 146 to display fused image 480 of the external scene, including the runway lights. It is noted that display 146 can be a head-up display (HUD), a head-down display (HDD), a video screen, computer monitor, video projector, and the like.

It is further noted that processor 140 can produce symbology 490, and overlay symbology 490 on fused image 480. Examples of symbology 490 include a flight path vector (FPV), a boresight symbol, an acceleration indicator, and the like. The overlay of symbology 490 on enhanced multispectral image 480 is stored in real-time in memory 148, illustrated in stage 410.

According to another mode of operation of system 100, is the case where only one of cameras 104, 106, 108, and 110 detects the EM radiation emanating from the airfield light emitters. In this case, system 100 produces enhanced multispectral image 480 relying on the image produced by the respective camera involved in the detection.

According to a further mode of operation of system 100, is the case where none of cameras 104, 106, 108, and 110 detect the EM radiation emanating from the airfield light emitters. In this case, hyper-range image 460 of the external scene, produced by EMCCD camera 102 is employed, whereas enhanced image 480 is not produced.

It will be appreciated by persons skilled in the art that the disclosed technique is not limited to what has been particularly shown and described hereinabove. Rather the scope of the disclosed technique is defined only by the claims, which follow.

1. Apparatus for detecting airfield light emitters, the apparatus comprising:
a plurality of light detection cameras, each detecting at least one respective waveband of electromagnetic radiation within the electromagnetic spectrum, each of said light detection cameras producing a plurality of respective spectral images; and
a processor, coupled with said light detection cameras, thereby generating a multispectral image of said airfield light emitters from said spectral images, said multispectral image comprising a multi-dimensional set of spectral values,
wherein said processor further determines which combination in said multi-dimensional set of spectral values corresponds with a plurality of distinct light emission characteristics of said airfield light emitters, by identifying a particular spectral signature corresponding to said multi-dimensional set of spectral values,
wherein said processor produces an enhanced image from those said spectral values of said multi-dimensional set of spectral values which correspond to said determined combination.

2. Apparatus for detecting airfield light emitters, the apparatus comprising:
at least one light detection camera, at least one of said at least one light detection camera detecting a plurality of respective wavebands of electromagnetic radiation within the electromagnetic spectrum, each said at least one light detection camera producing respective spectral images according to the corresponding wavebands thereof; and
a processor, coupled with said at least one light detection camera, thereby generating a multispectral image of said airfield light emitters from said respective spectral images, said multispectral image comprising a multi-dimensional set of spectral values,
wherein said processor further determines which combination in said multi-dimensional set of spectral values, corresponds with a plurality of distinct light emission characteristics of said airfield light emitters, by identifying a particular spectral signature corresponding to said multi-dimensional set of spectral values,
wherein said processor produces an enhanced image from those said spectral values of said multi-dimensional set of spectral values which correspond to said determined combination.

3. The apparatus according to claim 1, further comprising a plurality of optical filters, each associated with a respective one of said at least one waveband, each said optical filters optically coupled with a respective one of said light detection cameras.

4. The apparatus according to either of claims 1 and 2, wherein said processor further co-registers each said plurality of spectral images to a common reference frame.

5. The apparatus according to either of claims 1 and 2, further comprising a database, for storing a plurality of spectral signatures, each one of said plurality of spectral signatures being unique for a particular type of airfield light emitter and for a particular set of environmental conditions.

6. The apparatus according to claim 5, whereby said processor compares said multi-dimensional set of spectral values to said plurality of spectral signatures stored in said database.

7. The apparatus according to either of claims 1 and 2, wherein said airfield light emitters are selected from the list consisting of:
airfield runway edge lights;
runway centerline lights;
visual approach slope indicator (VASI) lights;
precision approach path indicator (PAPI) lights;
runway end identifier lights (REIL); and
touchdown zone lights (TDZL).

8. The apparatus according to either of claims 1 and 2, wherein said plurality of light detection cameras are charged coupled device (CCD) cameras.

9. The apparatus according to claim 8, wherein said CCD cameras have substantially similar spectral responses.

10. The apparatus according to claim 8, wherein said CCD cameras have substantially different spectral responses.

11. The apparatus according to claim 1, wherein said plurality of wavebands are selected from within a region of the electromagnetic spectrum selected from the list consisting of:
the ultraviolet region;
the visible region; and
the infrared region.

12. The apparatus according to claim 1, wherein at least one of said plurality of optical filters is an optical band-pass filter.

13. The apparatus according to claim 1, wherein said airfield light emitter is of a type selected from the list consisting of:
white light emitting diode (LED) type;
incandescent type;
gas discharge type;
arc type;
laser type;
sulfur type;
metal halide type; and
halogen incandescent type.

14. The apparatus according to either of claims 1 and 2, wherein said plurality of spectral signatures are dependent on a particular atmospheric medium.

15. The apparatus according to claim 14, wherein said particular atmospheric medium is selected from the list consisting of:
atmospheric dust;
rain drops;
ice crystals;
snow crystals;
smog;
haze;
water clouds;
fogs;
condensation nuclei;
hailstones;
a variety of pollens;
drizzle;
sea salt nuclei;
air; and
oil smokes.

16. The apparatus according to either of claims 1 and 2, further comprising a wide spectrum camera, coupled with said processor, for generating a hyper-range image of said airfield light emitters and the scene in which said airfield light emitters are located in.

17. The apparatus according to claim 16, wherein said wide spectrum camera is an electron-multiplying charged coupled device (EMCCD) camera.

18. The apparatus according to claim 16, wherein said wide spectrum camera is operative to detect electromagnetic radiation in at least one region selected from the list consisting of:
the visible region;
the near infrared (NIR) region;
the ultraviolet (UV) region;
the short-wavelength infrared (SWIR) region;
the mid-wavelength infrared (MWIR) region;
the long-wavelength infrared (LWIR) region;
the very long-wavelength infrared (VLWIR); and
the far infrared (FIR) region.

19. The apparatus according to claim 16, further comprising an image preprocessor, coupled between said wide spectrum camera and said processor, for preprocessing said hyper-range image.

20. The apparatus according to claim 19, wherein said preprocessing consists of at least one digital image process selected from the list consisting of:
feature extraction;
homomorphic filtering for image enhancement;
a signal-to-noise (SNR) enhancement algorithm;
thresholding;
time integration;
spatial high pass (HP) filtering;
pattern recognition;
peak light pattern recognition;
straight light pattern recognition; and
circle pattern recognition.

21. The apparatus according to claim 16, wherein said processor combines said hyper-range image with said enhanced image.

22. The apparatus according to either of claims 1 and 2, further comprising a display, coupled with said processor, for displaying said enhanced image to a user.

23. The apparatus according to either of claims 1 and 2, wherein said processor produces symbology and combines said symbology with said enhanced image.

24. The apparatus according to either of claims 1 and 2, wherein said apparatus is coupled inside a cockpit of an aircraft.

25. The apparatus according to claim 1, further comprising a respective image preprocessor for each of said plurality of light detection cameras, each said respective image preprocessor being coupled between a respective one of said plurality of light detection cameras and said processor, for preprocessing each said respective spectral image.

26. The apparatus according to claim 2, further comprising an image preprocessor being coupled between said at least one light detection camera and said processor, for preprocessing said respective spectral images.

27. The apparatus according to either of claims 25 and 26, wherein said preprocessing consists of at least one digital image process selected from the list consisting of:
feature extraction;
homomorphic filtering for image enhancement;
a signal-to-noise (SNR) enhancement algorithm;
thresholding;
time integration;
spatial high pass (HP) filtering;
pattern recognition;
peak light pattern recognition;
straight light pattern recognition; and
circle pattern recognition.

28. The apparatus according to either of claims 1 and 2, wherein said multi-dimensional set of spectral values is stored as a datacube.

29. The apparatus according to either of claims 1 and 2, wherein said processor determines said type of airfield light emitter corresponding to said airfield light emitters and the particular set of environmental conditions in which said airfield light emitters are located in according to said identified particular spectral signature.

30. The apparatus according to claim 24, further comprising a flight management system (FMS), coupled with said processor, for providing said processor with information regarding the position and the bearing of said aircraft relative to a ground target.

31. The apparatus according to claim 2, further comprising at least one optical filter, said at least one optical filter optically coupled with respective one of said at least one light detection camera.

32. The apparatus according to claim 1, further comprising at least one optical filter, said at least one optical filter optically coupled with respective one of said plurality of light detection cameras.

33. The apparatus according to claim 16, wherein said wide spectrum camera is selected from the list consisting of:
night vision device (NVD); and
active pixel sensor (APS).

34. The apparatus according to either of claims 31 and 32, wherein said at least one optical filter is an optical multi-band-pass filter.

35. The apparatus according to claim 2, further comprising a plurality of optical filters constructed in a rotating filter wheel configuration, each said optical filter is associated with a respective one of said at least one waveband, said rotating filter wheel configuration enabling each said light detection cameras to be optically coupled with a different one of said optical filters.

36. The apparatus according to claim 1, wherein said processor modifies the image saturation of at least one of said spectral images, by regulating an amplification level of the respective said light detection camera producing said spectral image.

37. The apparatus according to claim 36, wherein said modification is performed when a saturation threshold value of a respective one of said spectral images is exceeded.

38. Method for detecting airfield light emitters, the airfield light emitters having respective light emission characteristics, the method comprising the procedures of:
acquiring a plurality of spectral images from electromagnetic radiation emitted from said airfield light emitters in a plurality of wavebands within the electromagnetic spectrum, each said at least one spectral image corresponding to a particular one of said plurality of wavebands;
generating a multispectral image of said airfield light emitters from said spectral images, said multispectral image comprising a multi-dimensional set of spectral values; and
identifying a particular spectral signature of said airfield light emitters, from a combination of spectral values in a multi-dimensional set of spectral values, corresponding to said respective light emission characteristics.

39. The method according to claim 38, further comprising the procedure of generating an enhanced image from those said spectral values in said multi-dimensional set of spectral values corresponding to said combination.

40. The method according to claim 38, further comprising the procedure of storing a plurality of spectral signatures, each of said spectral signatures being unique for a particular type of said airfield light emitter and for a particular set of environmental conditions.

41. The method according to claim 38, further comprising the procedure co-registering each said spectral image to a common reference frame.

42. The method according to claim 40, further comprising the procedure of comparing said multi-dimensional set of spectral values to said stored spectral signatures.

43. The method according to claim 38, wherein said plurality of wavebands are selected from within a region of the electromagnetic spectrum from the list consisting of:
the ultraviolet region;
the visible region; and
the infrared region.

44. The method according to claim 38, further comprising the procedures of:
detecting electromagnetic radiation emitted from a scene in which said airfield light emitters are located in; and
generating a hyper-range image of said airfield light emitters and said scene in which said airfield light emitters are located in, from said detected electromagnetic radiation emitted from said scene.

45. The method according to claim 38, further comprising the procedure of preprocessing said at least one spectral image.

46. The method according to claim 45, wherein said procedure of preprocessing said at least one spectral image consists of at least one digital image process selected from the list consisting of:
feature extraction;
homomorphic filtering for image enhancement;
a signal-to-noise (SNR) enhancement algorithm;
thresholding;
time integration;
spatial high pass (HP) filtering;
pattern recognition;
peak light pattern recognition;
straight light pattern recognition; and
circle pattern recognition.

47. The method according to claim 44, further comprising the procedure of preprocessing said hyper-range image.

48. The method according to claim 47, wherein said procedure of preprocessing said hyper-range image consists of at least one digital image process selected from the list consisting of:
feature extraction;
homomorphic filtering for image enhancement;
a signal-to-noise (SNR) enhancement algorithm;
thresholding;
time integration;
spatial high pass (HP) filtering;
pattern recognition;
peak light pattern recognition;
straight light pattern recognition; and
circle pattern recognition.

49. The method according to claim 44, further comprising the procedures of:
generating an enhanced image from those said multi-dimensional set of spectral values corresponding to said combination, and
combining said hyper-range image with said enhanced image.

50. The method according to claim 39, further comprising the procedure of displaying said enhanced image to a user.

51. The method according to claim 39, further comprising the procedures of:
generating symbology; and
combining said symbology with said enhanced image.

52. The method according to claim 38, wherein said multi-dimensional set of spectral values is stored as a datacube.

53. The method according to claim 38, further comprising the procedure of determining type of said airfield light emitter corresponding to said airfield light emitters and the particular set of environmental conditions in which said airfield light emitters are located in, according to said identified particular spectral signature.

54. The method according to claim 38, further comprising the procedure of modifying image saturation of said spectral images.

55. The method according to claim 38, further comprising the procedure of modifying image saturation of at least one of said spectral images, by regulating an amplification level associated with a respective light detection camera that acquired said at least one of said spectral images.
